(19) United States
(12) Patent Application Publication
(10) Pub. No.: US 2026/0346627 A1
(43) Pub. Date: Nov. 5, 2026

(54) PRINTING APPARATUS, AND METHOD FOR CONTROLLING PRINTING APPARATUS

(71) Applicant: CANON KABUSHIKI KAISHA, Tokyo (JP)

(72) Inventors: YUKARI SUMIOKA, Kanagawa (JP); NOBORU KUNIMINE, Tokyo (JP); KEI YOSHIZAWA, Tokyo (JP)

(21) Appl. No.: 19/386,337

(22) Filed: Nov. 12, 2025

(30) Foreign Application Priority Data
Nov. 20, 2024 (JP) 2024-202235

(51) Int. Cl. B41J 29/38; B41J 2/21; B41J 11/00

(52) U.S. Cl. CPC B41J 29/38; B41J 2/2114; B41J 11/00222; B41J 11/007; B41J 11/008

(57) ABSTRACT

A printing apparatus includes: a printing unit configured to print an image by ejecting an ink to a print medium; a conveyance unit configured to convey the print medium on which the image is printed; a fixing unit configured to fix the image onto the print medium by heating the print medium on which the image is printed and that is conveyed by the conveyance unit; and a control unit configured to perform control while distinguishing a case where a lamination process is to be performed and a case where the lamination process is not to be performed in a case where the ink contains a wax.

### BACKGROUND

### Field of the Technology

The present disclosure relates to a printing apparatus including a fixing unit that fixes a printed image by using heat, and a control method of the printing apparatus.

### Description of the Related Art

There is a printing apparatus that prints an image by ejecting inks from nozzles of a print head to a print medium and obtains the print medium with the image fixed by heating. As a method of providing a certain level of fastness to the obtained print medium, there is known a lamination process in which the print medium to which the image is fixed is laminated with a transparent laminate film or the like.

In the lamination process described above, heating and pressure application are performed. There is a possibility that this heating and pressure application cause degradation of the image printed on the print medium. As a method of suppressing this image degradation, Japanese Patent Laid-Open No. H09-142048 discloses a technique for performing color conversion that suppresses the color output in the case where the lamination process is to be performed, compared to the case where the lamination process is not performed.

### SUMMARY

A printing apparatus according to one aspect of a technique of the present disclosure includes: a printing unit configured to print an image by ejecting an ink to a print medium; a conveyance unit configured to convey the print medium on which the image is printed; a fixing unit configured to fix the image onto the print medium by heating the print medium on which the image is printed and that is conveyed by the conveyance unit; and a control unit configured to perform control while distinguishing a case where a lamination process is to be performed and a case where the lamination process is not to be performed in a case where the ink contains a wax.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective diagram of a printing apparatus;

FIG. 2 is a schematic diagram illustrating a cross section of a printing apparatus including a fixing unit;

FIG. 3 is a schematic diagram of a print head;

FIG. 4 is a diagram illustrating a block configuration of a control system of the printing apparatus;

FIG. 5 is a flowchart illustrating a flow of a generation process of print data;

FIG. 6 is a diagram illustrating an example of a UI screen for selecting a print medium;

FIG. 7 is a diagram for explaining a multi-pass printing method;

FIG. 8 is a diagram for explaining mask patterns;

FIG. 9 is a schematic diagram of a cold laminator;

FIG. 10 is a diagram illustrating an UI screen example for setting a print mode;

FIG. 11 is a diagram illustrating a temperature profile of an ink film in fixing;

FIGS. 12A and 12B are schematic diagrams for explaining a state of a wax;

FIG. 13 is a diagram illustrating a temperature profile of the ink film in the fixing; and

FIGS. 14A and 14B are diagrams illustrating temperature profiles of the ink film in the fixing.

### DESCRIPTION OF THE EMBODIMENTS

Details of embodiments for carrying out techniques of the present disclosure are explained below with reference to the drawings. Note that the following embodiments do not limit the techniques of the present disclosure according to the scope of claims. Not all of combinations of features explained in the embodiments are necessarily essential for solving means of the techniques of the present disclosure, and multiple features may be combined in any combination. Note that the same configurations are explained by being denoted by the same reference numerals. Moreover, each of steps in flowcharts is described with “S” attached to the beginning of the step.

### First Embodiment

### Configuration of Printing Apparatus

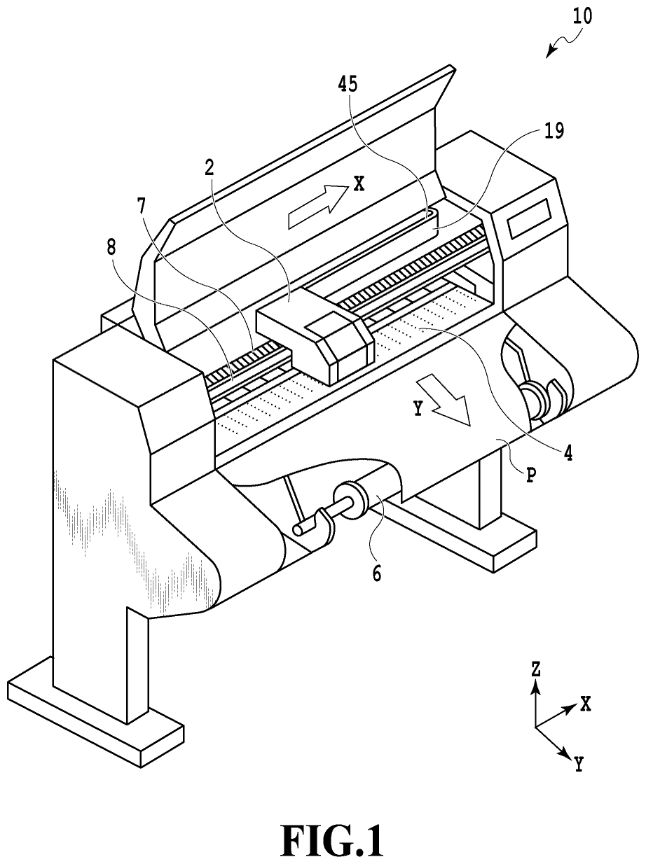

FIG. 1 is a perspective diagram illustrating an outer appearance of an inkjet printing apparatus 10 (hereinafter, referred to as printing apparatus 10) according to the present embodiment. The printing apparatus 10 is a so-called serial type printing apparatus. The printing apparatus 10 prints an image by performing reciprocal scanning of a print head in a +X direction (forward scanning direction) and an −X direction (return scanning direction) orthogonal to a Y direction (sub scanning direction) that is a conveyance direction of a print medium P. These forward and return scanning directions are referred to as main scanning direction.

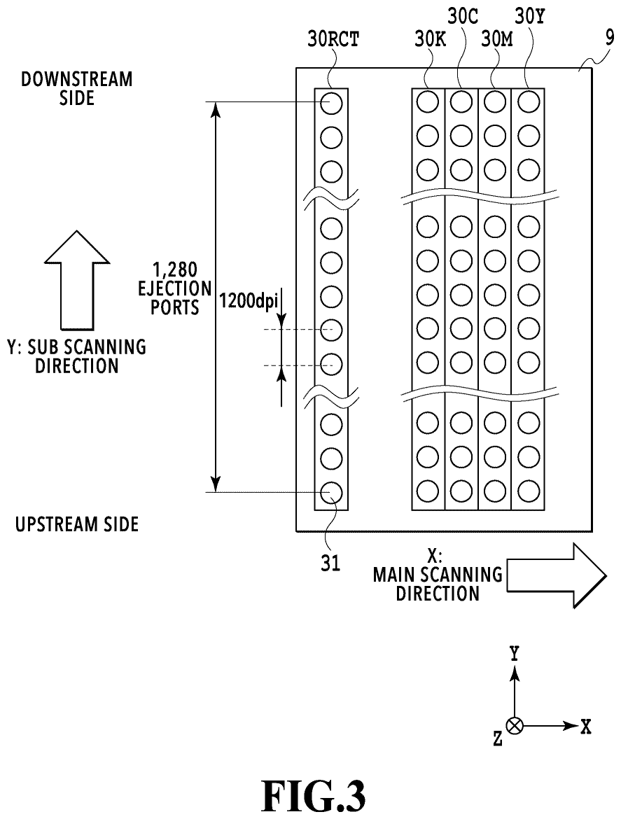

An outline of a configuration of this printing apparatus and an operation of the printing apparatus in printing are explained by using FIG. 1. First, the print medium P held a spool 6 is conveyed in the Y direction by a conveyance roller driven by a conveyance motor (not illustrated) via a gear. Meanwhile, a carriage motor (not illustrated) causes a carriage unit 2 to perform reciprocating scanning along a guide shaft 8 extending in the forward scanning direction and the return scanning direction, at a predetermined conveyance position. Then, in this scanning procedure, an ejection operation from ejection ports in a print head (see FIG. 3) mountable in the carriage unit 2 is performed at a timing based on a position signal obtained by an encoder 7, and printing is performed for a certain bandwidth corresponding to an array range of the ejection ports. In the present embodiment, the scanning can be performed at a scanning speed of 40 inches per second, and the ejection operation can be performed at a printing resolution of 1,200 dpi (1/1,200-inch interval). Then, the print medium P is conveyed, and printing is performed for the next bandwidth. Moreover, the scanning speed is variable, and the scanning can be performed at a speed equal to or higher than 40 inches per second.

Note that, although a carriage belt can be used for transmission of drive force from the carriage motor to the carriage unit 2, other drive methods may also be used. For example, there may be used other drive methods such as a method in which the printing apparatus includes a lead screw that is rotationally driven by the carriage motor and that extends in the forward scanning direction and the return scanning direction and an engagement portion that is provided in the carriage unit 2 and that engages with a groove of the lead screw.

The fed print medium P is pinched and conveyed by a feed roller and a pinch roller and guided to a print position (scanning region of the print head) on a platen 4. Since a face surface of the print head is normally capped in an idle state, the cap is opened prior to printing, and the print head and the carriage unit 2 are set to a scanning capable state. Thereafter, in the case where data for one scanning operation is accumulated in a buffer, the carriage motor performs the scanning of the carriage unit 2, and printing is performed as described above.

### Fixing Unit

The printing apparatus of the present embodiment includes a fixing step of fixing an image onto a print medium by heating the print medium on which an image has been printed by ejection of at least an ink. In the fixing step, it is necessary to melt a resin included in the ink to form a film, and cause most of liquid components such as water and a water-soluble organic solvent included in the ink to evaporate. As a heating method, there may be used, for example, a method of brining the print medium into direct contact with a heat source, a method using an infrared heater or a microwave irradiation to achieve heating without contact, and a method of blowing a room-temperature gas or a heated gas. A fixing temperature is desirably equal to or higher than a minimum film formation temperature of a fine particle to form the film of the resin.

Moreover, the printing apparatus is desirably configured to provide a temperature distribution in the print medium conveyance direction sufficient to secure a fixing period for supplying energy necessary for evaporation of most of the liquid components.

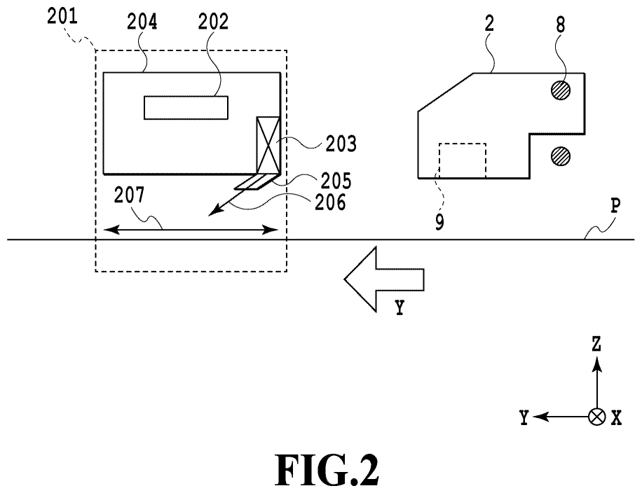

An example of a fixing unit suitable for carrying the fixing step of the present embodiment is explained by using the drawings. FIG. 2 is a schematic diagram illustrating a cross section of a printing apparatus including the fixing unit. Note that a cross section along the conveyance direction of the print medium is illustrated in FIG. 2.

A fixing unit 201 is provided downstream of a print region of a print head 9 in the conveyance direction Y of the print medium P. In the present embodiment, the fixing unit 201 is assumed to be a device configured to fix inks to the print medium P by blowing a heated gas 206. An image is printed on the print medium P with the inks ejected from nozzles of the print head 9, and then the not-illustrated feed roller conveys print medium P in the direction indicated by the arrow Y. Note that the size of the range indicated by the arrow 207 expresses the length of the fixing unit 201 in a travelling direction of the print medium P.

The fixing unit 201 is a device that is arranged above the print medium P and that includes a heater 202 and a blow unit that are mechanisms for blowing the heated gas. The heater 202 is a device such as a heating element that heats a gas, and may be any device whose temperature can be controlled. The heater 202 is preferably a device with high heat transmission efficiency to air. The blow unit is a device for blowing the heated gas 206 to the print medium P, and includes a blow fan 203, a blow duct 204, and a blown gas discharge portion 205. Note that the heated gas 206 is a gas heated by the heater 202, and is blown to the print medium P by the blow fan 203 through the blow duct 204 and the blown gas discharge portion 205.

The size of the range indicated by the arrow 207 described above is desirably configured to provide the temperature distribution in the conveyance direction of the print medium that can secure the fixing period for supplying the energy necessary for evaporation of most of the liquid components in the inks ejected to the print medium P.

Moreover, a temperature sensor (not illustrated) is provided inside the blow duct 204. The heater 202 is controlled based on temperature information obtained by measuring an environment temperature inside the blow duct 204 with the temperature sensor, and the temperature of the heater 202 is adjusted. This allows the temperature of the heated gas 206 blown to the print medium P to be adjusted. Since the temperature of the heated gas 206 can be adjusted as described above, the temperature of the print medium heated by the heated gas 206 can be adjusted. A large amount of vapor is generated in the fixing step in some cases. In the case where a large amount of vapor is generated as described above and the inside of the fixing unit 201 is filled with vapor, fixing efficiency decreases in some cases. Accordingly, a mechanism that collects vapor in the fixing unit 201 and discharges the vapor to the outside may be provided. Note that details of the fixing step such as fixing temperature control and fixing period control are described later.

### Print Head

The printing apparatus can perform so-called multi-pass printing in which an image is printed for a unit region (1/n band) on the print medium P in multiple times (n times) of scanning operations of the print head. Details of the multi-pass printing and an ejection port configuration for performing the multi-pass printing are described later.

FIG. 3 is a diagram schematically illustrating the print head 9 according to the present embodiment. The print head 9 includes an ejection port array 30K that ejects a black ink (K), an ejection port array 30C that ejects a cyan ink (C), an ejection port array 30M that ejects a magenta ink (M), and an ejection port array 30Y that ejects a yellow ink (Y) as inks containing a color material.

Since each of the black ink (K), the cyan ink (C), the magenta ink (M), and the yellow ink (Y) contains the color material, these inks are also referred to as color material inks in the following explanation to facilitate understanding.

Moreover, the print head 9 includes an ejection port array 30RCT that ejects a reactive liquid (RCT) containing no color material. The reactive liquid contains no color material, but contains a reactant that reacts with the color materials contained in the color material inks. The reactive liquid can reduce bleeding by coming into contact with the color material inks on the print medium P.

Note that, although the four types of color material inks (K, C, M, and Y) are provided as the color material inks in the present embodiment, the present disclosure is not limited to this. For example, light color inks such as a light cyan ink (Lc), a light magenta ink (Lm), and a gray ink (GY) may be provided in addition to the four types of color material inks (K, C, M, and Y). Moreover, particular color inks such as a green ink (G), an orange ink (OR), a red ink (R), a blue ink (B), and a white ink (W) may be provided in addition to the four types of color material inks (K, C, M, and Y).

The ejection port arrays 30RCT, 30K, 30C, 30M, and 30Y are arranged side by side in the order of description from the left side to the right side in the X direction.

In each of the ejection port arrays 30RCT, 30K, 30C, 30M, and 30Y, 1,280 ejection ports 31 that eject the corresponding ink are aligned in the Y direction (conveyance direction) at a density of 1,200 dpi. Note that an ejection amount of the ink ejected in one operation from one ejection port 31 is about 6 picoliters (pl).

Each of these ejection port arrays 30RCT, 30K, 30C, 30M, and 30Y is connected to an ink tank (not illustrated) storing the corresponding ink, and the ink is supplied. Note that the print head 9 and the ink tank may be configured to be integral, or configured to be capable of being separated from each other.

### Configuration of Control System

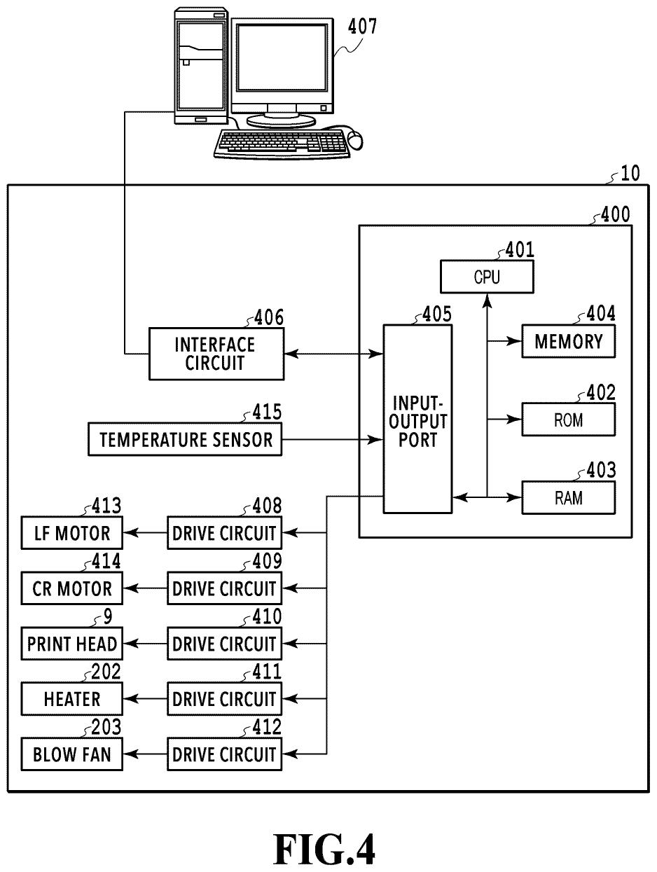

FIG. 4 is a diagram illustrating a block configuration of a control system of the printing apparatus 10. The printing apparatus 10 includes a control unit 400 that controls the entire printing apparatus 10. The control unit 400 includes a CPU 401 that executes a printing operation and processing operations such as computation, selection, determination, and control. The control unit 400 includes a ROM 402, a RAM 403, a memory 404, an input-output port 405, and the like. The ROM 402 stores processing programs and the like for image data and various types of control executed by the CPU 401. The RAM 403 is used as a buffer of print data or the like. Various pieces of data such as mask patterns to be described later are stored in the memory 404. Various drive circuits 408 to 412 are connected to the input-output port 405. The drive circuit 408 drives a conveyance motor (LF motor) 413. The drive circuit 409 drives a carriage motor (CR motor) 414. The drive circuit 410 drives ink ejection from the print head 9. The drive circuit 411 drives the heater 202. The drive circuit 412 drives the blow fan 203. Moreover, the control unit 400 is connected to a host apparatus (PC) 407 via an interface circuit 406. The printing apparatus 10 further includes a temperature sensor 415 connected to the control unit 400. The temperature sensor 415 outputs the temperature information, obtained by measuring the environment temperature in the blow duct 204 of the fixing unit 201, to the input-output port 405 of the control unit 400. Note that the control unit 400 may control the LF motor 413, the CR motor 414, the print head 9, the heater 202, the blow fan 203, and the like based on the obtained temperature information.

### Generation Process of Print Data

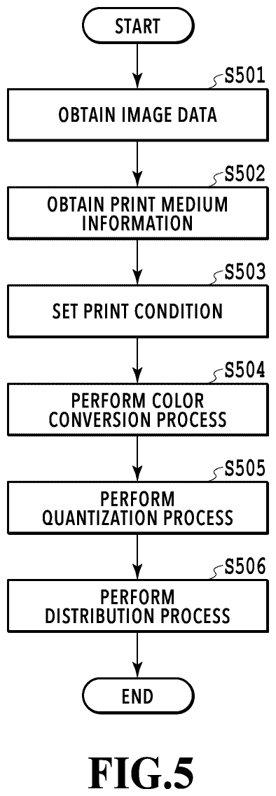

FIG. 5 is a flowchart illustrating a flow of a generation process of the print data used in printing. Note that the process illustrated in FIG. 5 is implemented by the CPU 401 (FIG. 4) of the printing apparatus 10 executing a control program stored in the ROM 402 (FIG. 4). This process is started by an instruction of printing performed by the user in the host apparatus 407 (FIG. 4).

In S501, the printing apparatus 10 obtains RGB image data received from the host apparatus 407.

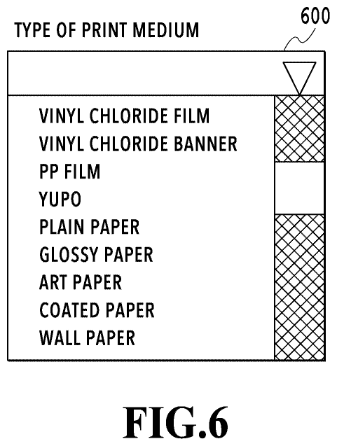

In S502, the printing apparatus 10 obtains information on the type of print medium to be used in printing. In the present embodiment, a user performs a user input of selecting the print medium to be used in the printing, and the printing apparatus 10 obtains the information on the selected type of print medium based on the user input. For example, a CPU of the host apparatus 407 and the like perform display control of displaying a user interface (UI) screen (see FIG. 6) on a display device of the host apparatus 407 such as a monitor. Then, the CPU of the host apparatus 407 and the like receives a user operation of selecting one type of print medium on which the printing is to be performed, from among multiple types of print media through the UI screen.

### UI Screen for Print Medium Selection

FIG. 6 is a diagram schematically illustrating a screen (user interface; UI) displayed on the display device of the host apparatus 407 in the case where the user inputs the information on the type of print medium. As illustrated in FIG. 6, the UI screen 600 is displayed such that one of existing nine types of print media is selectable. The nine types of print media are “vinyl chloride film”, “vinyl chloride banner”, “PP film”, “Yupo”, “plain paper”, “glossy paper”, “art paper”, “coated paper”, and “wall paper”.

Then, the information on the selected type of print medium is inputted into the printing apparatus 10 via the host apparatus 407, and is obtained in S502.

Note that, although the form in which the user inputs the information on the type of print medium through the UI screen is explained herein, the present disclosure is not limited to this. There may be adopted a form in which a sensor for determining the type of print medium is installed in the printing apparatus, and the information on the type of print medium corresponding to a determination result of the sensor is automatically obtained. Moreover, there may be provided a configuration in which the user can newly register a type of print medium other than the types of print media registered in advance.

In S503, the printing apparatus 10 sets one condition corresponding to the information on the type of print medium obtained in S502, from among multiple print conditions.

Information on the multiple types of print media is registered in the printing apparatus 10 in advance. A condition in lamination control and a condition in non-lamination control used for each print medium are stored in the ROM 402 of the printing apparatus 10. Note that the user may add information on the types of print media not registered in advance. Moreover, the above-mentioned conditions may be adjusted by a user operation performed via the host apparatus 407 or a liquid crystal panel installed in the printing apparatus 10.

In S504, the printing apparatus 10 performs a color conversion process of converting image data of values indicated by RGB signals (8-bit, 256-level RGB values) to multivalued data corresponding to each of the inks (C, M, Y, K, and RCT) used in printing. The color conversion process generated multivalued data expressed by 8-bit, 256-level information determining the gradations of each of the inks in each of pixel groups formed of multiple pixels. The color conversion process is performed by using a look-up table defining a correspondence relationship between the RGB value before the conversion and each of values (C, M, Y, and K values) indicated by C, M, Y, and K signals corresponding to the respective colors of the color inks after conversion and a value (RCT value) indicated by a signal of the reactive liquid. A look-up table that varies depending on the print condition set in S503 is used for the reactive liquid.

In S505, the printing apparatus 10 performs a quantization process of quantizing the multivalued data. The quantization process generates quantization data expressed by 1-bit, binary information determining ejection or non-ejection of each of the inks for each of the pixels. Note that a method such as a dithering process or an error-diffusion process can be used as a method of quantization.

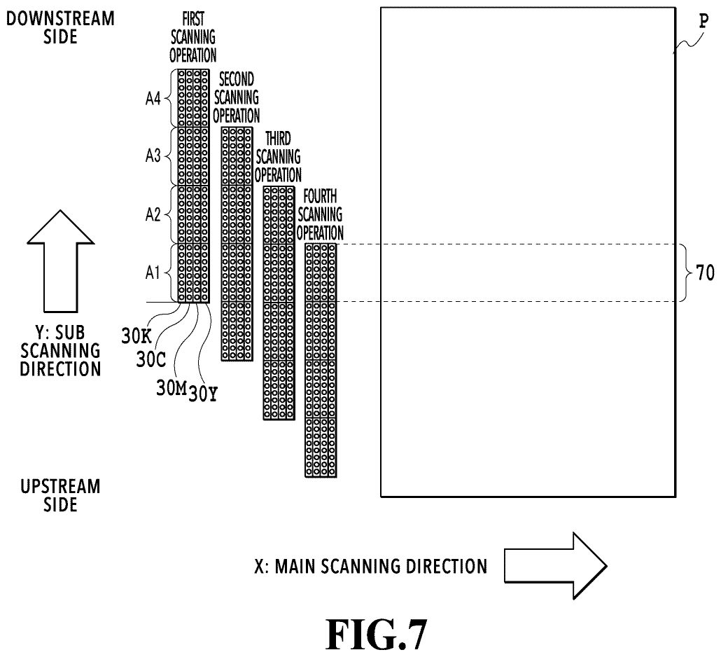

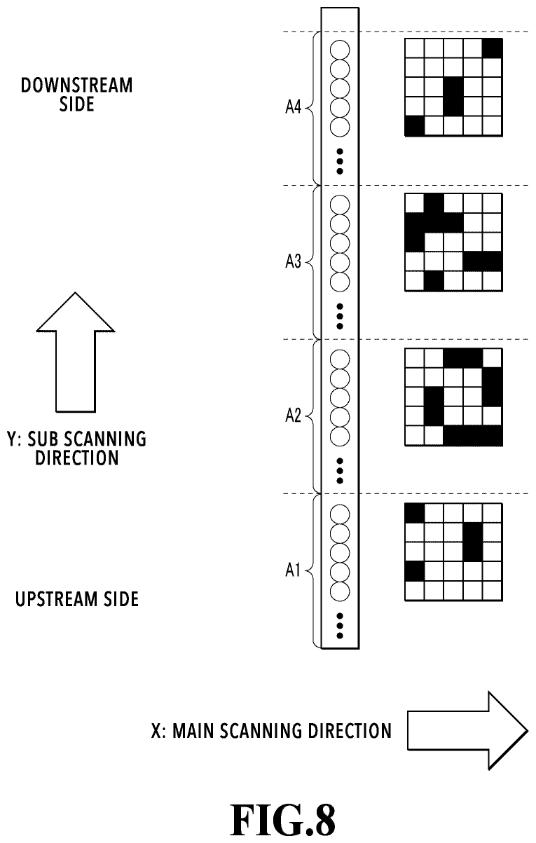

In S506, the printing apparatus 10 performs a distribution process of distributing the quantization data of each of the inks to multiple scanning operations of the print head in multi-pass printing illustrated in FIGS. 7 and 8 to be described later. The distribution process generates print data expressed by the one-bit, binary information determining ejection or non-ejection of each of the inks for each of the pixels in each of multiple scanning operations to be performed for the unit region on the print medium.

In the present embodiment, the inks are ejected from the print head 9 according to the print data generated as described above. Note that, although the form in which the CPU 401 in the printing apparatus 10 executes all processes of S501 to S506 is explained, the present disclosure is not limited to this. For example, there may be adopted a form in which the host apparatus 407 executes all processes of S501 to S506. Moreover, for example, there may be adopted a form in which the host apparatus 407 executes the processes of S501 to S504, and the printing apparatus 10 executes the processes of S505 to S506.

### Multi-Pass Printing Method

In the present embodiment, the printing is performed in multiple scanning operations performed on the unit region on the print medium P. A method of printing an image by the so-called multi-pass printing is explained. In order to facilitate understanding of explanation, explanation is given of the case where the printing is performed with the same mask patterns applied to all inks as illustrated in FIG. 7 in S506 of FIG. 5. Note that, in this description, explanation is given by using an example in which four scanning operations are performed on the unit region to complete the printing.

FIG. 7 is a diagram for explaining a multi-pass printing method performed in the present embodiment. In the present embodiment, the inks are ejected in the four scanning operations performed on the unit region, respectively, from four ejection port groups A1 to A4 formed by dividing each of the ejection port arrays 30K, 30C, 30M, and 30Y in the Y direction in FIG. 7. Note that, although the print medium P is conveyed downstream in the Y direction between the scanning operations of the print head 9 to be described later in actual, in FIG. 7, the print head 9 is illustrated to be moved upstream in the Y direction between the scanning operations to facilitate understanding of the explanation.

First, in a scanning operation of first time (first scanning operation), the scanning of the print head 9 is performed in a positional relationship in which a unit region 70 on the print medium P and the ejection port group A1 in an ejection port array 22 face each other. During this scanning operation, the inks corresponding to each type are ejected from the ejection port group A1 onto the unit region 70, based on the print data generated in S506 for the first scanning operation. After completion of the first scanning operation, the print medium is conveyed in the Y direction by a distance corresponding to one ejection port group.

Next, in the second scanning operation, the inks are ejected from the ejection port group A2 onto the unit region 70. Then, the print medium is conveyed and ink is ejected from the print head alternately, thereby executing the ink ejection from the ejection port groups A3 to A4 on the unit region 70 during the third and fourth scanning operations. The multi-pass printing for the unit region 70 is thereby completed.

In mask patterns illustrated FIG. 8, pixels painted in black indicate pixels (hereinafter, also referred to as print permitted pixels) for which ejection of the inks is permitted in the case where ejection of the inks is determined in the quantization data. Pixels illustrated in white indicate pixels (hereinafter, referred to as non-print-permitted pixels) for which ejection of the inks is not permitted even in the case where ejection of the inks is determined in the quantization data. Moreover, FIG. 8 illustrates the mask patterns each having a size of 5 pixels×5 pixels, and the distribution process is performed by repeatedly applying these mask patterns in the X direction and the Y direction to the entire quantization data corresponding to each unit region.

The number of pixels for which permission of ejection is given and that are present in the four mask patterns illustrated in FIG. 8 is 5 pixels×5 pixels=25 pixels. Specifically, in the case where the pixels for which permission of ejection is given in the four 5 pixels×5 pixels mask patterns are added up, a print permission ratio is 100%. Print data for application of each ink in each print scanning operation can be generated by performing a logical product (AND) process between part (size of 5 pixels×5 pixels) of the binary data of each ink and the mask pattern corresponding to each scanning operation (each pass).

Focusing on the mask pattern corresponding to each scanning operation, in the mask pattern corresponding to the first scanning operation (ejection port group A1), four print permitted pixels are arranged. Accordingly, the print permission ratio of the mask pattern corresponding to the first scanning operation is about 16%(=4/25×100). Moreover, the print permission ratios of the mask patterns corresponding to the second scanning operation (ejection port group A2) to the fourth scanning operation (ejection port group A4) are 32%, 36%, and 16%, respectively. Accordingly, in the case where these mask patterns are used, ejection of the ink can be distributed over an entire region of the ejection port array of the print head. Note that the patterns illustrated in FIG. 8 are diagrams illustrated by extracting part of the mask patterns to facilitate understanding of the explanation, and the print permission ratios slightly vary from the above-mentioned print permission ratios.

### Lamination Process

A lamination process is a process performed on a print product that is the print medium on which an image is printed, and is generally performed by a laminator that is separate from the printing apparatus 10 and that is provided in a stage subsequent to a fixing unit of the printing apparatus 10. Accordingly, in the printing apparatus 10, the print medium P on which an image is printed is temporarily wound around a winding spool to form a roll-shaped wound medium 6. Then, the following method is generally performed: the roll-shaped wound medium 6 is loaded into a laminator; the unwound print medium P and a sheet-shaped laminate film are made to adhere to each other; and then cutting is performed according to the size of the print medium P.

### Cold Laminator

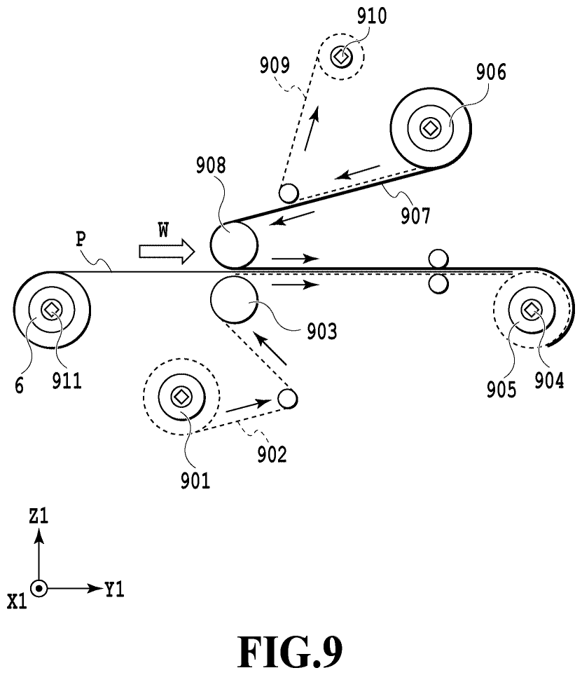

FIG. 9 is a schematic diagram of a general cold laminator used in the present embodiment. An under film 902 is unwound from a roll-shaped under film 901 located in a lower portion of the cold laminator 900, and is wound on a winding spool 904 via a lower pressure bonding roller 903 to form a roll-shaped wound medium 905. Moreover, a cold laminate film 907 is unwound from a roll-shaped laminate film 906 located in an upper portion of the cold laminator 900, and is similarly wound on the winding spool 904 via an upper pressure bonding roller 908 to form the roll-shaped wound medium 905. In this case, since a release paper 909 of the laminate film is wound on a winding spool 910, an adhesive portion of the cold laminate film is exposed before a point where the cold laminate film 907 is conveyed by the upper pressure bonding roller 908. The under film 902 and the cold laminate film 907 in which the above-mentioned adhesive portion is exposed are conveyed while being brought into pressure contact, respectively, by the lower pressure bonding roller 903 and the upper pressure bonding roller 908, and form the roll-shaped wound medium 905.

In the cold laminator 900, the roll-shaped wound medium 6 is attached to an attachment spool 911 provided in the cold laminator 900. Then, the cold laminator 900 unwinds the roll-shaped wound medium 6 as the print medium P. This print medium P is conveyed in a W direction (conveyance direction), is made to pass between the lower pressure bonding roller 903 and the upper pressure bonding roller 908, and is similarly wound on the winding spool 904. Conveying the print medium P between the rollers as described above causes the print medium P to adhere to the cold laminate film 907 in which the adhesive is exposed, and forms the roll-shaped wound medium 905 subjected to the lamination process.

The lamination process method is not limited to the process method using the cold laminator. For example, there may be adopted a process method such as a method in which a dedicated or general-purpose laminator performs hot lamination by applying heat to a laminate film such as an OPP film or a PET film and pressure-bonding the laminate film. Moreover, the laminate film used in the lamination process may be a laminate film made of a synthetic resin such as acryl. Furthermore, there may be used a lamination film obtained by performing a process such as a process in which an application liquid is coated or sprayed on an ink layer surface, the application liquid containing an UV curing component, a weather resistance improvement agent such as a UV absorbing agent or an antioxidant, and the like in a synthetic resin such as acryl.

Note that, although the cold laminator 900 provided separately from the printing apparatus 10 is explained in the present embodiment, the present disclosure is not limited to this. A laminator provided integrally with the printing apparatus 10 may be used.

Moreover, although explanation is given of the case where the laminate film used in the lamination process is a laminate film that corresponds to the print medium P and that is recommended by a manufacturer of the print medium in the present embodiment, the present disclosure is not limited to this. The laminate film may be a laminate film not corresponding to the print medium P.

### Material Outline

Details of each of the inks forming an ink set used in the present embodiment are explained. Hereinafter, “parts” and “%” are percent by mass unless otherwise noted.

### Composition of Each Ink

A composition of each ink is explained below in detail.

The color material inks (K, C, M, Y) and the reactive liquid (RCT) used in the present embodiment all contain a water-soluble organic solvent. The water-soluble organic solvent is preferably a solvent with a boiling point of 150° C. or more and 300° C. or less from a viewpoint of wettability and a moisture retaining property of the face surface of the print head 9. Moreover, the water-soluble organic solvent is particularly preferably a ketone compound such as acetone or cyclohexanone, a propylene glycol derivative such as tetraethylene glycol dimethyl ether, a heterocyclic compound with a lactam structure typified by N-methyl-pyrrolidone and 2-pyrrolidone, or the like, from viewpoints of function of a film forming aid on a resin fine particle and swelling and solubility to the print medium P in which a layer of the resin is formed. The content of the water-soluble organic solvent is preferably 3 wt % or more and 30 wt % or less from a viewpoint of ejection performance. Examples of the water-soluble organic solvent specifically include: alkyl alcohols with a carbon number of 1 to 4 such as, for example, methyl alcohol, ethyl alcohol, n-propyl alcohol, isopropyl alcohol, n-butyl alcohol, sec-butyl alcohol, and tert-butyl alcohol; amides such as dimethylformamide and dimethylacetamide; ketones and keto alcohols such as acetone or diacetone alcohol; ethers such as tetrahydrofuran and dioxane; polyalkylene glycols such as polyethylene glycol and polypropylene glycol; ethylene glycol; alkylene glycols in which an alkylene group contains two to six carbon atoms such as propylene glycol, butylene glycol, triethylene glycol, 1,2,6-hexanetriol, thiodiglycol, hexylene glycol, and diethylene glycol; lower alkyl ether acetates such as polyethylene glycol monomethyl ether acetate; glycerin; lower alkyl ethers of polyhydric alcohol such as ethylene glycol monomethyl (or ethyl) ether, diethylene glycol methyl (or ethyl) ether, and triethylene glycol monomethyl (or ethyl) ethers; polyhydric alcohols such as trimethylolpropane and trimethylolethane; N-methyl-2-pyrrolidone; 2-pyrrolidone; 1,3-dimethyl-2-imidazolidinone; and the like. The above-mentioned water-soluble organic solvents may be used alone or as a mixture. Moreover, deionized water is desirably used as water. Note that the content of the water-soluble organic solvent in the reactive liquid (RCT) is not limited to a particular content, and a debubbling agent, a preservative, a fungicide, and the like may be added as appropriate to the color material inks (K, C, M, and Y) in addition to the above-mentioned components to provide desired physical property values as necessary.

Moreover, the color material inks (K, C, M, and Y) and the reactive liquid (RCT) used in the present embodiment all contain a surfactant. The surfactant is used for the purpose of improving wettability and a spreading property of the inks on the print medium P. The larger the additive amount of the surfactant is, the stronger the property of reducing the surface tensions of the inks is, and the more the wettability and the spreading property of the inks on the print medium P is improved.

In the present embodiment, a small amount of an acetylene glycol EO adduct and the like are added as the surfactant to adjust the static surface tension of each ink to 30 dyn/cm or less and to adjust differences among the static surface tensions of the color material inks to 2 dyn/cm or less. To be more specific, the static surface tensions of the respective color material inks are adjusted to be within a range of about 22 dyn/cm to 24 dyn/cm. Fully-automatic surface tensiometer CBVP-Z (manufactured by Kyowa Interface Science Co., Ltd.) is used for the measurement of the static surface tensions of the inks. Note that the measurement device is not limited to the above-mentioned device given as an example, as long as the measurement device can measure the static surface tensions of the inks.

Moreover, a pH of each color material ink in the present embodiment is stable on the alkaline side, and the value thereof is 8.5 to 9.5. A pH of each color material ink is preferably 7.0 or more and 10.0 or less from a viewpoint of preventing elution and degradation of members in contact with the color material ink in the printing apparatus and the print head 9, a decrease in solubility of the resin dispersed in the color material ink, and the like. For the measurement of the pH, ph METER F-52 manufactured by Horiba, Ltd. is used. Note that the measurement device is not limited to the above-mentioned device given as an example, as long as the measurement device can measure the pH of each ink.

### Water-Soluble Resin Emulsion

Each of the color material inks used in the present embodiment contains a water-soluble resin emulsion.

In the present embodiment, “water-soluble resin emulsion” means a polymer fine particle existing in a state where the particle is dispersed in water. Specifically, examples of the water-soluble resin emulsion include: an acryl resin fine particle synthesized by subjecting a monomer such as (meth) acrylic acid alkyl ester or (meth) acrylic acid alkyl amide to emulsion polymerization or the like; a styrene-acryl resin fine particle synthesized by subjecting monomers of styrene and (meth) acrylic acid alkyl ester or (meth) acrylic acid alkyl amide to emulsion polymerization or the like; a polyethylene resin fine particle; a polypropylene resin fine particle; a polyurethane resin fine particle; a styrene-butadiene resin fine particle; and the like. Moreover, the water-soluble resin emulsion may be a particle such as a core-shell type resin fine particle in which a core portion and a shell portion forming the resin fine particle vary in the composition of polymer or a resin fine particle obtained by using an acryl fine particle synthesized in advance to control the particle size as a seed particle and performing emulsion polymerization around the seed particle. Furthermore, the water-soluble resin emulsion may be a particle such as a hybrid resin fine particle in which varying resin fine particles such as an acryl resin fine particle and a urethane resin fine particle are chemically bonded to each other.

### Wax

Each of the color material inks used in the present embodiment contains a wax as a lubricant that improves fastness.

Examples of the wax includes synthetic wax particles such as Fischer-Tropsch wax (EMUSTAR-6315) manufactured by Nippon Seiro Co., Ltd. and polyolefin wax (Hi-Tech E9500) manufactured by Toho Chemical Industry Co., Ltd. Moreover, examples of the wax include natural wax particles such as carnauba wax (CELOSOL 524) manufactured by Chukyo Yushi Co., Ltd. and paraffin wax (AQUACER 497) manufactured by BYK-Chemie Japan KK. Moreover, the lubricant may be a silicone oil, and examples of the silicone oil include polyether-modified silicone (BYK 333) manufactured by BYK-Chemie Japan KK.

### Reactive Liquid

In the present embodiment, a system that performs printing by using a reactive liquid for insolubilizing part or all of solid components in the color material inks is adopted as necessary to solve image problems such as bleeding and beading.

The following substances are given as examples of a reactant of the reactive liquid used to insolubilize resins, dissolved dyes, and dispersed pigments. For example, such substances include multivalent metal ions (for example, magnesium sulfite, magnesium nitrate, magnesium chloride, calcium lactate, aluminum sulfite, ferric chloride, and the like). As a type of coagulation effect using cation as described above, a system using a cationic high-polymer coagulant with low molecular weight may be used for purpose of charge neutralization of the water-soluble resin emulsion and insolubilization of anionic soluble substances.

Moreover, an insolubilizing system using a reactive liquid utilizing pH differences can be given as another reaction system. As described above, most of the color material inks used in the inkjet printing are generally stable on the alkaline side due to properties such as properties of the color material inks, and the pH of each ink is generally 7.0 or more and 10.0 or less. From an industrial viewpoint or in consideration of effects on external environments and the like, the pH is mainly set around 8.5 to 9.5 in many examples. In order to aggregate and solidify the color material ink with such a system, an acidic solution is mixed into the ink, and the pH is changed. This can break a stable state, and cause the dispersed components to aggregate. An acidic solution can be also used as the reactive liquid for purpose of achieving such an effect.

### Print Medium

The printing apparatus 10 of the present embodiment can perform printing on multiple types of print media. For example, the printing apparatus 10 can perform printing on a non-absorbent print medium impermeable to moisture included in the inks, a low-absorbency print medium with low absorbency of moisture included in the inks, an inkjet-application print medium with high moisture absorbency, and the like.

### Print Mode

The printing apparatus 10 of the present embodiment is configured to be capable of selecting control for lamination (hereinafter, described as lamination control) or control for non-lamination (hereinafter, described as non-lamination control) as a print mode. The lamination control is a print mode in which good adhesion is achieved between the print product and a transparent material layer (laminate layer) used in the lamination process. The non-lamination control is a print mode in which high productivity can be achieved. In the case where the lamination control is selected, a control condition in which a coating of the wax is prevented from forming on a surface of an ink film is used, and this can achieve good adhesion between the print product and the transparent material layer (laminate layer) used in the lamination process. Note that the formation of the coating of the wax does not mean that the coating of the wax covers 100% of the entire surface of the ink film, but means that the coverage of the wax on the surface of the ink film is increased.

### Selection of Control

In the present embodiment, the user selects the non-lamination control or the lamination control, and the control is performed based on a selection result. For example, the CPU of the host apparatus 407 and the like perform display control of displaying a UI screen for selecting the non-lamination control or the lamination control on the display device such as the monitor, and receives selection by the user through the UI screen.

### UI Screen

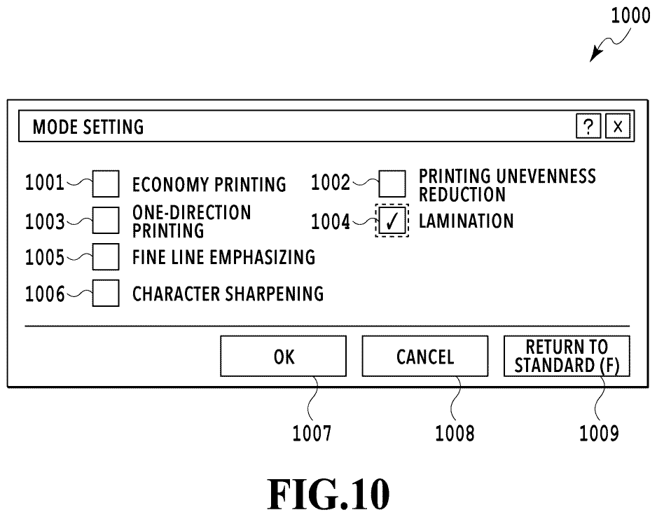

FIG. 10 is a diagram illustrating an example of the UI screen. An UI screen 1000 is a screen for setting a mode in the case where an image is to be printed. The UI screen 1000 is displayed on the display device such as the monitor of the host apparatus 407. The UI screen 1000 includes check boxes 1001 to 1006, respectively, for “economy printing”, “printing unevenness reduction”, “one-direction printing”, “lamination”, “fine line emphasizing”, and “character sharpening”. The UI screen 1000 includes an “OK” button 1007, a “cancel” button 1008, and a “restore standard (F)” button 1009.

In the case where the check box 1004 of “lamination” receives a user operation and is checked, the lamination control is selected. In the case where the check box 1004 of “lamination” receives no user operation and is not checked, the non-lamination control is selected. Note that, although the example in which the UI screen 1000 is displayed on the display device of the host apparatus 407 is explained, the present disclosure is not limited to this. For example, the UI screen 1000 may be displayed on a touch panel that is an operation unit included in the printing apparatus 10 and that receives the user operation.

Then, the selected control is inputted into the printing apparatus 10 via the host apparatus 407, and a generation process of print data is performed based on a non-lamination control condition or a lamination control condition stored in the ROM 402. Moreover, a fixing condition of the non-lamination control or the lamination control is selected.

Regarding the print condition and the fixing condition described above, one condition may be automatically determined, or one condition selected by a user operation from among multiple conditions displayed in a list may be determined.

Moreover, the print condition and the fixing condition described above may be adjustable by a user operation performed via the host apparatus 407 or the liquid crystal panel included in the printing apparatus 10.

### Lamination Control

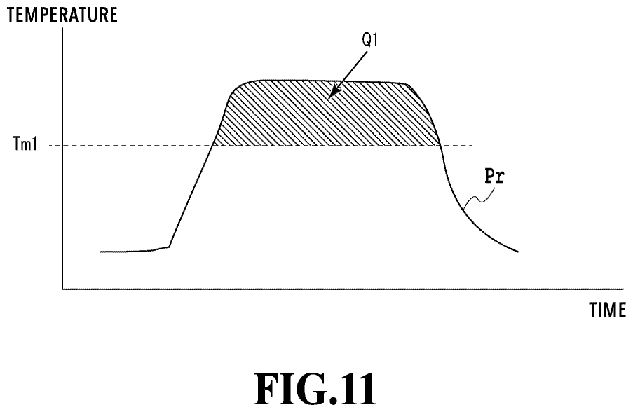

The lamination control according to the present embodiment is explained by using FIGS. 11 to 13.

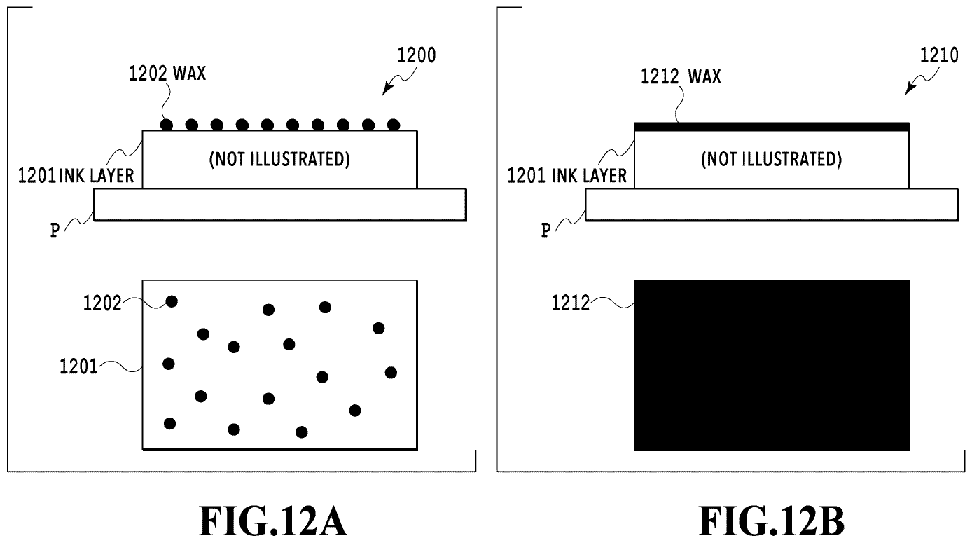

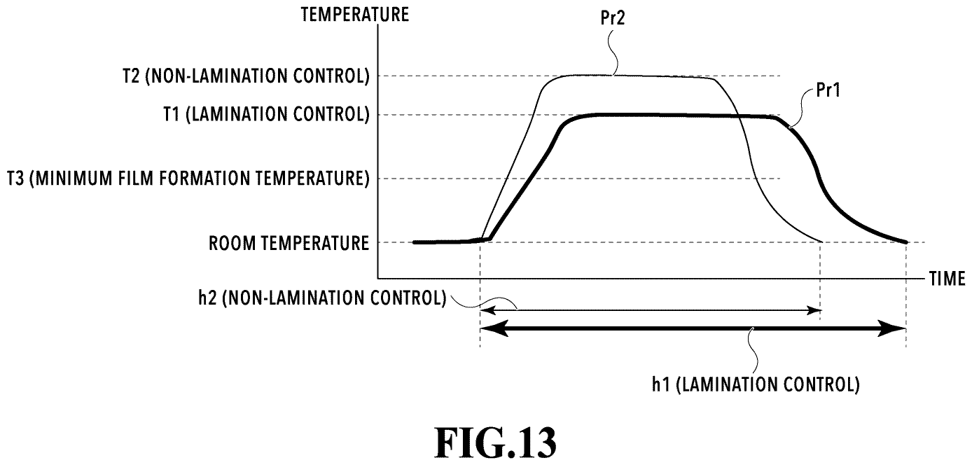

FIG. 11 is a diagram illustrating a temperature profile Pr of the ink film in the fixing. FIGS. 12A and 12B are schematic diagrams for explaining a state of the wax included in each ink. FIG. 13 is a diagram illustrating a temperature profile of the ink film in the fixing according to the present embodiment.

As illustrated in FIG. 11, a melting point that is a temperature at which the wax starts to melt in an ink film in the fixing is referred to as Tm1. A quantity of heat applied to the ink film formed of the ink on the print medium at a temperature equal to or higher than the melting point Tm1 of the wax is referred to as heat quantity Q1.

In the present embodiment, the heat quantity Q1 is adjusted to be smaller than a heat quantity at which the coating of the wax is formed, and as illustrated in FIG. 12A, the ink film expressed by an ink layer 1201 is formed in a state where a wax 1202 is dispersed without forming the coating. In the state where the wax is dispersed without forming the coating as described above, good adhesion can be achieved between the not-illustrated material layer (laminate layer) and a print product 1200 that is the print medium on which an image is printed.

Meanwhile, in the case where the heat quantity Q1 is larger than the heat quantity at which the coating of the wax is formed, as illustrated in FIG. 12B, the formation of the coating of the wax progresses, and a wax layer 1212 is formed over the entire surface of the ink layer 1201. In the case where the wax layer 1212 is formed over the entire surface of the ink layer 1201 as described above, adhesion between the not-illustrated material layer (laminate layer) and a print product 1210 that is the print medium on which an image is printed decreases in some cases. Meanwhile, since the quantity of heat applied to the ink film expressed by the ink layer 1201 increases, a drying characteristic is improved, and productivity is improved.

Accordingly, it is important to appropriately control the quantity of heat applied to the ink film depending on the productivity and depending on whether the lamination process that is a post-process is performed or not, and obtain the print product that is the print medium to which an image is fixed. In the present embodiment, control is performed in the following relationship between the lamination control and the non-lamination control for each print medium in which the adhesion between the print product and the material layer (laminate layer) changes depending on the quantity of applied heat, and the productivity and the lamination adhesion are thereby improved. Note that the lamination control is control executed in the case where the lamination process of laminating the transparent material is performed on the print medium (print product) to which an image is fixed. The non-lamination control is control executed in the case where the lamination process is not performed on the print medium (print product) to which an image is fixed. The above-mentioned heat quantity Q1 expresses a quantity of heat applied at a temperature equal to or higher than the melting point Tm1 at which the wax starts to melt in the ink film in the fixing.

Q1 (non-lamination control)>Q1 (lamination control)
In the present embodiment, explanation is given of an aspect in which, in order to establish the above-mentioned relationship, the fixing unit is controlled such that the temperature of the ink film in the fixing maintains the following relationship between the non-lamination control and the lamination control.

T2 (non-lamination control)>T1 (lamination control)>T3 (minimum film formation temperature)
T1 (lamination control) expresses a temperature of the ink film in the lamination control. T2 (non-lamination control) expresses a temperature of the ink film in the non-lamination control. T3 (minimum film formation temperature) expresses a minimum film formation temperature that is a minimum temperature at which the resin included in the ink melts and forms a film. Controlling the fixing temperature at or above the minimum film formation temperature of the resin allows the resin of the ink film to form the film. Accordingly, sufficient fastness can be obtained in both of the ink film in which the wax 1202 not forming the coating is present as illustrated in FIG. 12A and the ink film in which the wax layer 1212 forming the coating is present as illustrated in FIG. 12B.

Moreover, T2 (non-lamination control) is set to a high temperature equal to or higher than the melting point Tm1 at which the wax starts to melt in the ink film, to improve productivity. T1 (lamination control) is set to a temperature lower than the melting point Tm1 to improve adhesion of the laminate layer. T3 (minimum film formation temperature) is a temperature lower than T1 (lamination control), and is desirably a temperature lower than the melting point Tm1 at which the wax starts to melt.

A melting characteristic of a wax particle in the ink film is explained. In the above description, it is assumed that the melting point Tm1 is a critical temperature of the wax particle and the wax particle melts at or above Tm1 to simplify the explanation. However, it is determined from differential scanning calorimeter measurement (DSC analysis) and the like that an actual heat melting characteristic of the wax particle is not a sharp heat melting characteristic. Reasons for this are assumed to be reasons such as crystalline nature of the wax particle that is a polymer material and the fact that the resin material such as the emulsion included in the ink has amorphous nature. As a result, an endothermic peak occurring in the melting of the wax particle has a broad shape, and the melting of the wax particle is assumed to start from a temperature several degrees lower than the peak temperature Tm1.

A temperature difference between T2 (non-lamination control) and T1 (lamination control) is preferably set in consideration of the melting point characteristic of the wax particle described above, temperature variation in the fixing unit in the printing apparatus, and the like. For example, in the case where the temperature at which the wax starts to melt is 3° C. lower than the melting point Tm1 of the wax and the temperature variation in the fixing unit is 5° C., the larger value is used as the temperature difference between the two controls. In this case, T1 (lamination control) is set to a value 5° C. lower than T2 (non-lamination control). Meanwhile, in the case where the temperature at which the wax starts to melt is 7° C. lower than Tm1 and the temperature variation in the fixing unit is similarly 5° C., T1 (lamination control) is set to a value 7° C. lower than T2 (non-lamination control). Setting the temperature difference between the two controls as described above can achieve stable adhesion for the laminate film also under the temperature variation in the fixing unit. The temperature difference between the fixing temperature T1 (lamination control) and the fixing temperature T2 (non-lamination control) is preferably 3° C. or more, more preferably 5° C. or more, though this depends on the type of wax material to be used, a characteristic of the temperature variation in the fixing unit, and the like. A print product with good productivity and good adhesion of the laminate film can be thereby obtained.

The fixing unit included in the printing apparatus of the present embodiment adjusts the temperature of the ink film. In this case, if physical properties of the print medium such as thermal conductivity, wettability, and permeability vary, an energy amount necessary in application of a certain quantity of heat to the ink film printed on the print medium also varies. Moreover, the temperature profile of the ink film in the fixing unit also varies depending on the print medium. Accordingly, the control condition of the fixing unit also varies depending on the print medium.

Since setting the temperature of the fixing unit described above by checking the melting state of the wax is difficult, lamination adhesion force may be used as a determination index.

In the present embodiment, for each print medium, the lamination process is performed on ink films that are fixed with the temperature of the ink film in the fixing varied, the lamination adhesion force for each temperature is measured, and a temperature at which the adhesion force drops by 50% is determined as T1 (lamination control). The adhesion force is measured by using, for example, coating peel analyzer (VPA-3) manufactured by Kyowa Interface Science Co., Ltd. In the present embodiment, a print product subjected to the lamination process and left to stand for 24 hours is attached to a stainless-steel plate, and the peel force of the laminate film is measured with the peel angle set to 180° and the peel rate set to 30 mm per minute. Moreover, although the case where the threshold is set to 50% is explained above, the present disclosure is not limited to this. For example, it only necessary that sufficient lamination suitability is obtained, and the above-mentioned threshold may be set to any value such as 40% that is lower than 50%.

Moreover, although the example in which the fixing temperature T2 (non-lamination control) is set to a temperature higher than the melting point Tm1 of the wax to improve productivity is described, the present disclosure is not limited to this. For example, in a print mode in which there is no need to improve the productivity or in the case where the fixing temperature cannot be raised due to a heat resistance characteristic of the print medium or the like, the configuration may be such that the fixing temperature T2 (non-lamination control) is set to or below the melting point Tm1 of the wax and no lamination mode is set. Specifically, the fixing temperature T2 (non-lamination control) and the fixing temperature T1 (lamination control) may be set to the same temperature (T2=T1).

In the case where the supplied energy falls short of energy necessary for the fixing due to reducing of the fixing temperature in the above-mentioned lamination control, a shortfall in the energy may be compensated by increasing a total fixing period. In FIG. 13, the arrow h2 (non-lamination control) expresses the fixing period in the non-lamination control. The arrow h1 (lamination control) expresses the fixing period in the lamination control. The fixing period is controlled by adjusting the conveyance speed of the print medium P. For example, the conveyance speed of the print medium P, that is the fixing period (h1 (lamination control) and h2 (non-lamination control)) can be controlled by adjusting the scanning speed, the number of times of scanning operations, and a waiting time between the scanning operations in the multi-pass printing method. In detail, increasing the number of times of scanning operations while maintaining the scanning speed without change increases each of the fixing period h1 (lamination control) and the fixing period h2 (non-lamination control). Increasing the waiting time between the scanning operations while maintaining the scanning speed and the number of times of scanning operations without change can also increase each of the fixing period h1 (lamination control) and the fixing period h2 (non-lamination control).

Scotchcal™ Graphic Film IJ1220-10 vinyl chloride film manufactured by 3M company is used as the print medium, and Scotchcal™ overlaminate film IJ4132 manufactured by 3M company is used as the laminate film. The minimum film formation temperature is 65° C., and a print ink applying amount is 32 ng/600 dpi. Note that dpi indicates a relative resolution indicating the number of printed dots per one inch.

Regarding “Tm1”, the adhesion force of the laminate film is measured, and is used as the index for determining “Tm1”. The lamination process is performed on each of multiple ink films fixed at varying fixing temperatures, and the adhesion force of the lamination film for each fixing temperature is measured. Then, it is confirmed that the fixing temperature at which the adhesion force drops by 50% is 85° C. The gas velocity of the heated gas generated by the fixing unit is 5 m/sec, and is common in both of the non-lamination control and the lamination control. The fixing temperature T2 (non-lamination control) is set to 90° C, the fixing period h2 (non-lamination control) is set to 70 seconds, the fixing temperature T1 (lamination control) is set to 80° C., and the fixing period h1 (lamination control) is set to 100 seconds.

The fixing period can be generally controlled by reducing the scanning speed, increasing the waiting time between the scanning operations, and reducing the conveyance speed of the print medium in the multi-pass printing. In the present embodiment, the waiting time between the scanning operations is controlled. Specifically, in the multi-pass printing in the non-lamination control, the number of passes is set to six, the scanning speed is set to 60 inches per second, and the waiting time between the scanning operations is set to 0 seconds. In the multi-pass printing in the lamination control, the number of passes is set to six, the scanning speed is set to 60 inches per second, and the waiting time between the scanning operations is set to 0.7 seconds.

Note that, in the case where the supplied energy does not fall short of the energy necessary for the fixing and is sufficient even if the fixing temperature is reduced, the lamination control may be the same as the non-lamination control.

As explained above, in the present embodiment, in the case where the inks contain the wax, the printing apparatus performs control while distinguishing the case where the lamination process is to be performed and the case where the lamination process is not to be performed. This allows the lamination process to be performed appropriately in the case where the inks containing the wax are used.

There is a case where an ink containing a wax are used to improve the fastness of an image itself printed on a print medium. Assume a case where the ink containing the wax as described above is ejected to the print medium to print an image, and a lamination process is performed on the print medium to which the image is fixed by heating. In this case, a laminate film sometimes does not adhere to the print medium.

According to the present embodiment, it is possible to appropriately perform the lamination process in the case where the ink containing the wax is used.

### Second Embodiment

In the present embodiment, explanation is given of an aspect in which the applied heat quantity is made smaller than a heat quantity necessary for the coat formation of the wax by controlling a time period in which the temperature is equal to or higher the melting point Tm1 of the wax. Note that differences from the first embodiment are mainly explained in the present embodiment.

### Control Setting

The printing apparatus of the present embodiment has a function capable of setting one of the lamination control that is the print mode suitable for the lamination process on the print product and the non-lamination control that is the print mode not suitable for the lamination process on the print product, for each print medium. A fixing period h11 in the lamination control and a fixing period h12 in the non-lamination control have the following relationship.

The fixing period in which the temperature is equal to or higher than the melting point Tm1 at which the wax starts to melt in the ink film satisfies the following condition.
h12 (non-lamination control)>h11 (lamination control)

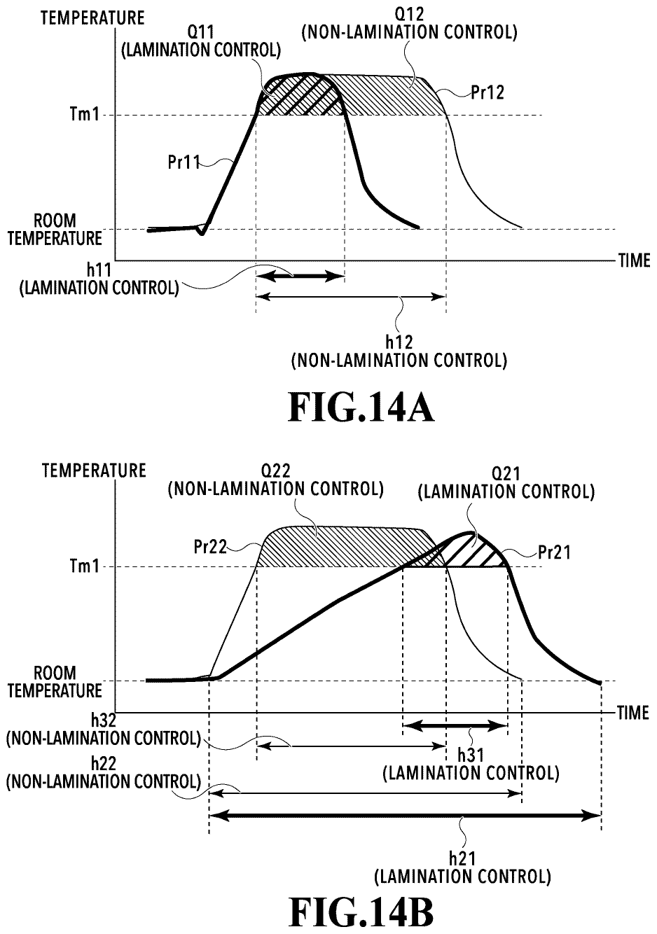

FIGS. 14A and 14B are each a diagram illustrating a temperature profile of the ink film in the fixing according to the present embodiment.

### Method of Controlling Fixing Periods h11 and h12

In the present embodiment, the fixing periods h11 and h12 are adjusted by controlling the conveyance speed of the print medium.

For example, as illustrated in FIG. 14A, the fixing period h11 (lamination control) and the fixing period h12 (non-lamination control) can be adjusted by changing the conveyance speed of the print medium P without changing the heating temperature of the fixing unit.

Specifically, at least one of increasing the scanning speed, reducing the number of times of scanning operations, or reducing the waiting time between the scanning operations in the multi-pass printing method is performed. This can make the fixing period h11 (lamination control) shorter than the fixing period h12 (non-lamination control).

The print medium, the laminate film, the minimum film formation temperature, the print ink applying amount, the melting point Tm1 of the wax, and the gas velocity are assumed to be the same as those in the first embodiment, and detailed explanation thereof is omitted. For example, in the non-lamination control, the fixing temperature T2 (non-lamination control) is 90° C., and the fixing period h12 (non-lamination control) in which the temperature is equal to or higher than the melting point Tm1 of the wax is 70 seconds. Meanwhile, in the lamination control, the fixing temperature T1 (lamination control) is 90° C., and the fixing period h11 (lamination control) in which the temperature is equal to or higher than the melting point Tm1 of the wax is 40 seconds. It is confirmed that the fixing period h11 (lamination control) can be made shorter than the fixing period h12 (non-lamination control) as described above.

The control of the fixing period in the present embodiment is achieved by controlling the waiting time between the scanning operations as in the first embodiment. Specifically, the waiting time in the non-lamination control is set by adding 0.7 seconds to the waiting time in the lamination control.

Although the reduction of the fixing period may cause the fixing energy to be insufficient and cause the fastness of the print product to decrease in the lamination control of the present embodiment, the fixing period is reduced based on an idea that the fastness is guaranteed by performing the lamination process after the printing, and this can improve productivity.

Moreover, a fixing period h31 (lamination control) can be made shorter than a fixing period h32 (non-lamination control) also by changing the temperature profile.

In the present embodiment, the fixing period h31 (lamination control) is controlled by adjusting the gas velocity of the heated gas generated by the fixing unit.

For example, controlling the gas velocity at which the fixing unit blows the heated gas enables control of a tilt of rising in each of temperature profiles Pr21 and Pr22 as illustrated in FIG. 14B. Specifically, the blow fan 203 of the fixing unit is controlled to reduce the gas velocity at which the heated gas is blown. The tilt in the temperature profile Pr21 (lamination control) in the case where the temperature reaches the temperature equal to or higher than the melting point Tm1 of the wax can be thereby made gentler than that in the case of the temperature profile Pr22 (non-lamination control).

Moreover, in the case where the supplied energy falls short of the energy necessary for the fixing by an amount corresponding to the reduction of the fixing period h31 (lamination control), a total fixing period h21 is preferably increased to make up for the energy. In this case, combining the control of increasing the fixing period enables control of the temperature profile.

A profile of a change in the lamination adhesion force with respect to the fixing period is measured, and it is confirmed from this measurement that increasing the fixing period causes the lamination adhesion force to gradually decrease over time. This is assumed to be because the lamination adhesion force depends on a melting time period of the wax component included in the ink, the melting speed of the wax component, the reaction speed of the wax component, and the physical properties of the print medium. For example, for a vinyl chloride film with low thermal conductivity, the lamination adhesion force drops by 50% in 20 seconds. In this case, the fixing period h31 (lamination control) is set to 20 seconds or less. Meanwhile, for a print medium with high thermal conductivity such as a transparent PET film, the lamination adhesion force drops by 50% in 10 seconds. In this case, the fixing period h31 (lamination control) is set to 10 seconds or less.

Though depending on the type of the wax material to be used and the physical properties of the print medium, setting the fixing period (lamination control) to 20 seconds or less, more preferably 10 seconds or less suits most print media.

Moreover, for example, multiple sets (for example two or three sets) of the heater 202, the blow fan 203, the blow duct 204, and the blown gas discharge portion 205 may be provided in the Y direction of the fixing unit. In the case where multiple sets are provided as described above, the tilt of the rising in the profile can be controlled also by varying settings of the blown air temperature and the gas velocity between the sets.

For example, assume that three sets of the heater 202, the blow fan 203, the blow duct 204, and the blown gas discharge portion 205 are provided in the Y direction. The fixing temperature T2 (non-lamination control) is set to blown air temperatures of 90° C./90° C./90° C. from the carriage unit 2 side, and the gas velocity is set to 3 m/second in all sets. The fixing period h32 (non-lamination control) in which the temperature is equal to or higher than the melting point Tm1 of the wax is set to 70 seconds, and a total fixing period h22 is set to 80 seconds. The fixing temperature T1 (lamination control) is set to blown air temperatures of 70° C./80° C./90° C. from the carriage unit 2 side, and the gas velocity is set to 3 m/second in all sets. The fixing period h31 (lamination control) in which the temperature is equal to or higher than the melting point Tm1 of the wax is set to 20 seconds, and the total fixing period h21 is set to 100 seconds.

It is confirmed that performing the above-mentioned control enables formation of the ink film in which no coating of the wax is formed in the lamination control as illustrated in FIG. 12A. Note that the formation of the coating of the wax does not mean that the coating of the wax covers 100% of the entire surface of the ink film, but means that the coverage of the wax on the surface of the ink film is increased.

As explained above, according to the present embodiment, a print product with high fastness can be obtained. Moreover, print control with high productivity can be performed by selecting the non-lamination control. The lamination process can be performed appropriately by selecting the lamination control.

Moreover, in the present embodiment, the fixing temperature (non-lamination control) of the fixing unit and the fixing temperature (lamination control) of the fixing unit may vary, as long as the coating of the wax is not formed.

### Other Embodiments

Although the present embodiment is explained by using the serial type printing apparatus, the present disclosure is not limited to this. A full multi type printing apparatus using a line head having the same length as the width of the print medium may be used.

Moreover, in the present embodiment, explanation is given of the example in which a good image in which bleeding, beading, and the like is suppressed is printed by using the reactive liquid to insolubilize part or all of solid components in the color material inks. However, the present disclosure is not limited to this. A good image in which bleeding, beading, and the like is suppressed may be printed by using, for example, a heating mechanism provided in a platen, instead of the reactive liquid.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present embodiment, the lamination process can be appropriately performed in the case where the ink containing the wax is used.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-202235, filed Nov. 20, 2024, which is hereby incorporated by reference herein in its entirety.

What is claimed is:

1. A printing apparatus comprising:
a printing unit configured to print an image by ejecting an ink to a print medium;
a conveyance unit configured to convey the print medium on which the image is printed;
a fixing unit configured to fix the image onto the print medium by heating the print medium on which the image is printed and that is conveyed by the conveyance unit; and
a control unit configured to perform control while distinguishing a case where a lamination process is to be performed and a case where the lamination process is not to be performed in a case where the ink contains a wax.

2. The printing apparatus according to claim 1, wherein the control unit controls at least one of the printing unit, the conveyance unit, or the fixing unit.

3. The printing apparatus according to claim 2, wherein the control unit controls, in the case where the lamination process is to be performed, the fixing unit such that a heat quantity in the heating is smaller than a heat quantity in the heating in the case where the lamination process is not to be performed.

4. The printing apparatus according to claim 3, wherein the control unit controls, in the case where the lamination process is to be performed, the fixing unit such that the heat quantity in the heating is larger than a heat quantity necessary for film formation of the ink.

5. The printing apparatus according to claim 2, wherein the control unit controls, in the case where the lamination process is to be performed, the fixing unit such that a film temperature of the ink is lower than a film temperature of the ink in the case where the lamination process is not to be performed.

6. The printing apparatus according to claim 5, wherein the control unit controls, in the case where the lamination process is to be performed, the fixing unit such that the film temperature of the ink is higher than a film formation temperature of the ink.

7. The printing apparatus according to claim 5, further comprising a measurement unit configured to measure a temperature at which the fixing unit heats the print medium, wherein
the control unit controls, based on the temperature measured by the measurement unit, the fixing unit.

8. The printing apparatus according to claim 5, wherein the control unit controls, in the case where the lamination process is to be performed and fixing energy falls short of fixing energy necessary for the fixing, the conveyance unit or the printing unit such that a fixing period taken for the fixing is longer than a fixing period in the case where the lamination process is not to be performed.

9. The printing apparatus according to claim 2, wherein the control unit controls, in the case where the lamination process is to be performed, at least one of the printing unit, the conveyance unit, or the fixing unit such that a time period in which a temperature is equal to or higher than a melting point of the wax is shorter than a time period in which the temperature is equal to or higher than the melting point of the wax in the case where the lamination process is not to be performed.

10. The printing apparatus according to claim 9, wherein the control unit adjusts a conveyance speed of the print medium by controlling the conveyance unit.

11. The printing apparatus according to claim 10, wherein the control unit controls the printing unit such that the printing unit performs at least one of increasing a scanning speed of the printing unit, reducing the number of times of scanning operations of the printing unit, or reducing a waiting time between scanning operations in which scanning of the printing unit is performed.

12. The printing apparatus according to claim 9, wherein the control unit adjust a gas velocity at which the fixing unit blows a heated gas by controlling the fixing unit.

13. The printing apparatus according to claim 12, wherein the control unit controls the fixing unit such that the gas velocity is reduced.

14. The printing apparatus according to claim 9, wherein the control unit controls, in the case where the lamination process is to be performed and fixing energy falls short of fixing energy necessary for the fixing, the conveyance unit or the printing unit such that a fixing period taken for the fixing is longer than a fixing period in the case where the lamination process is not to be performed.

15. The printing apparatus according to claim 14, wherein the control unit controls the printing unit such that the number of times of scanning operations of the printing unit is increased while a scanning speed of the printing unit is unchanged.

16. The printing apparatus according to claim 14, wherein the control unit controls the printing unit such that a waiting time between scanning operations in which scanning of the printing unit is performed is increased while a scanning speed of the printing unit and the number of times of scanning operations of the printing unit are unchanged.

17. The printing apparatus according to claim 1, further comprising a setting unit configured to set whether to perform the lamination process or not.

18. The printing apparatus according to claim 17, further comprising a display control unit configured to display, on a display unit, a UI screen for setting whether to perform the lamination process or not, wherein
the setting unit sets, based on a user operation performed through the UI screen, execution of the lamination process.

19. The printing apparatus according to claim 1, wherein the control unit controls at least one the printing unit, the conveyance unit, or the fixing unit depending on a type of the printing medium.

20. The printing apparatus according to claim 1, further comprising a processing unit provided in a stage subsequent to the fixing unit and configured to perform the lamination process on the print medium to which the image is fixed.

21. The printing apparatus according to claim 20, wherein the processing unit is provided integrally with the printing apparatus or is provided separately from the printing apparatus.

22. A method for controlling a printing apparatus including a printing unit configured to print an image by ejecting an ink to a print medium, a conveyance unit configured to convey the print medium on which the image is printed, and a fixing unit configured to fix the image onto the print medium by heating the print medium on which the image is printed and that is conveyed by the conveyance unit, the method comprising:
performing control while distinguishing a case where a lamination process is to be performed and a case where the lamination process is not to be performed in a case where the ink contains a wax.
